(19) United States
(12) Patent Application Publication
(10) Pub. No.: US 2008/0072977 A1
(43) Pub. Date: Mar. 27, 2008

(54) PILOT-OPERATED VALVES AND MANIFOLD ASSEMBLIES

(75) Inventors: Paul A. George, Rocky River, OH (US); George A. Cantley, Akron, OH (US)

Correspondence Address: PEARNE & GORDON LLP, 1801 EAST 9TH STREET, SUITE 1200, CLEVELAND, OH, 44114-3108, US

(73) Assignee: CURTISS-WRIGHT FLOW CONTROL CORPORATION, Roseland, NJ (US)

(21) Appl. No.: 11/862,605

(22) Filed: Sep. 27, 2007

Related U.S. Application Data
(60) Provisional application No. 60/847,425, filed on Sep. 27, 2006.

(51) Int. Cl. F15B 13/042; F16K 11/06; F16K 31/124

(52) U.S. Cl. 137/625.6; 251/28

(57) ABSTRACT

A pilot-operated valve can include a manifold assembly with a plate cavity and a valve plate positioned within the cavity. The valve plate includes a first surface facing a cavity surface and a second surface facing away from the first surface. The valve plate also includes a first aperture extending through the first surface and the second surface and configured to be aligned with a first opening of the manifold body and a second aperture extending through the first surface and the second surface and configured to be aligned with the second opening of the manifold body. The manifold assembly further includes at least one seal configured to provide a first fluid tight seal between the first aperture and the first opening and configured to provide a second fluid tight seal between the second aperture and the second opening.

### CROSS-REFERENCE TO RELATED APPLICATIONS

This application claims the benefit of U.S. Provisional Application No. 60/847,425, filed Sep. 27, 2006, the entire disclosure of which is hereby incorporated herein by reference.

### FIELD OF THE INVENTION

The present invention relates to valves and manifold assemblies, and more particularly to pilot-operated valves and manifold assemblies.

### BACKGROUND OF THE INVENTION

U.S. Pat. No. 3,215,163 to Henderson discloses a two-position, four-way, pilot-operated valve utilizing a flanged seal. The flanged seal includes a flange that co-operates with a surface of an inner cylinder cap.

U.S. Pat. No. 4,450,869 to Acker discloses a pilot-operated valve including a balanced valving assembly with a floating valve member and a floating reaction member urged in opposite directions by a central coil spring. The floating valve member is urged against a valve plate secured to a surface of a manifold body. The manifold body is formed as a casting, such as an aluminum casting. The valve plate is formed from stainless steel or other suitable corrosion and wear-resistant material. As shown, the valve plate is secured to the manifold body by a suitable adhesive so that a fluid tight joint is provided along the interface between the valve plate and the manifold body.

FIG. 1 depicts yet another example of a conventional pilot-operated valve including a balanced valving assembly 342 with a floating valve member 344 and a floating reaction member 346 urged in opposite directions by a central coil spring 347. The floating valve member 344 is urged against a valve plate 370. The valve plate 370 is secured to a surface 382 of a manifold body 310 by way of an adhesive layer 383. The manifold body is formed as an aluminum casting and the valve plate is made from a hardened stainless steel.

Such valves have been used, for example, in the range shifting system for heavy truck transmissions.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a manifold assembly comprises a manifold body including a bottom surface, a plate cavity recessed from the bottom surface and at least partially defined by a cavity surface, a first opening extending through the cavity surface, a second opening extending through the cavity surface. The manifold body further includes a first control port in fluid communication with the first opening and a second control port in fluid communication with the second opening. The manifold body also includes a manifold supply opening and a supply port in fluid communication with the manifold supply opening. The manifold assembly further includes a valve plate positioned within the plate cavity. The valve plate includes a first surface facing the cavity surface and a second surface facing away from the first surface. The valve plate also includes a first aperture extending through the first surface and the second surface and configured to be aligned with the first opening, and a second aperture extending through the first surface and the second surface and configured to be aligned with the second opening. The manifold assembly further includes at least one seal configured to provide a first fluid tight seal between the first aperture and the first opening and configured to provide a second fluid tight seal between the second aperture and the second opening.

In accordance with another aspect of the present invention, a manifold assembly comprises a manifold body including a bottom surface, a plate cavity recessed from the bottom surface and at least partially defined by a cavity surface. The manifold body includes a first opening extending through the cavity surface and a second opening extending through the cavity surface. The manifold body further includes a first control port in fluid communication with the first opening and a second control port in fluid communication with the second opening. The manifold body also includes a manifold supply opening extending through the bottom surface of the manifold body and a supply port in fluid communication with the manifold supply opening. The manifold assembly further includes a valve plate including a material that has a higher wear resistance than a material of the manifold body. The valve plate is configured to be keyed within the plate cavity in at least one selected orientation. A depth of the plate cavity is greater than a thickness of the valve plate and the valve plate includes a first surface facing the cavity surface and a second surface facing away from the first surface. The valve plate includes a first aperture extending through the first surface and the second surface and configured to be aligned with the first opening. The valve plate also includes a second aperture extending through the first surface and the second surface and configured to be aligned with the second opening. The second surface of the valve plate is configured to be arranged substantially flush with the bottom surface of the manifold body. The manifold assembly further includes at least one seal configured to provide a first fluid tight seal between the first aperture and the first opening and configured to provide a second fluid tight seal between the second aperture and the second opening. The at least one seal is configured to bias at least a portion of the valve plate to extend out of the plate cavity.

In accordance with another aspect of the present invention, a pilot-operated valve comprises a body assembly including a body member with a top surface, a central passage, a balanced valve assembly opening extending through the top surface, and a body supply opening extending through the top surface. The pilot-operated valve further includes a manifold assembly mounted to the body member. The manifold assembly includes a manifold body with a bottom surface, a plate cavity recessed from the bottom surface and at least partially defined by a cavity surface. The manifold body also includes a first opening extending through the cavity surface and a second opening extending through the cavity surface. The manifold body further includes a first control port in fluid communication with the first opening and a second control port in fluid communication with the second opening. The manifold body also includes a manifold supply opening aligned with the body supply opening and a supply port in fluid communication with the manifold supply opening. The manifold assembly further comprises a valve plate positioned within the plate cavity. The valve plate includes a first surface facing the cavity surface and a second surface facing away from the first surface. The valve plate further includes a first aperture extending through the first surface and the second surface and aligned with the first opening. The valve plate also includes a second aperture extending through the first surface and the second surface and aligned with the second opening. The manifold assembly further comprises at least one seal configured to provide a first fluid tight seal between the first aperture and the first opening and configured to provide a second fluid tight seal between the second aperture and the second opening. The pilot-operated valve further includes a slide assembly received in the central passage of the body member. The slide assembly includes a floating valve member extending at least partially through the balanced valve assembly opening and biased against the second surface of the valve plate. The floating valve member is configured to be placed in selective communication with the first aperture and the second aperture.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a conventional pilot-operated valve;

FIG. 2 is an example of a pilot-operated valve incorporating aspects of the present invention;

FIG. 3 a partial sectional view of the example pilot-operated valve along line 3-3 of FIG. 2;

FIG. 4 an exploded lower perspective view of a manifold assembly of the example pilot-operated valve of FIG. 2;

FIG. 5 is a top plan view of a manifold block of the manifold assembly of FIG. 4;

FIG. 6 is a sectional view of the manifold block along line 6-6 of FIG. 5;

FIG. 7 is a first side view of the manifold block of FIG. 5;

FIG. 8 is a second side view of the manifold block of FIG. 5;

FIG. 9 is a third side view of the manifold block of FIG. 5;

FIG. 10 is a sectional view of the manifold block along line 10-10 of FIG. 9;

FIG. 11 is a bottom view of the manifold block of FIG. 5;

FIG. 12 is a top view of a valve plate from the manifold assembly of FIG. 4; and

FIG. 13 is a sectional view of the valve plate along line 13-13 of FIG. 12.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

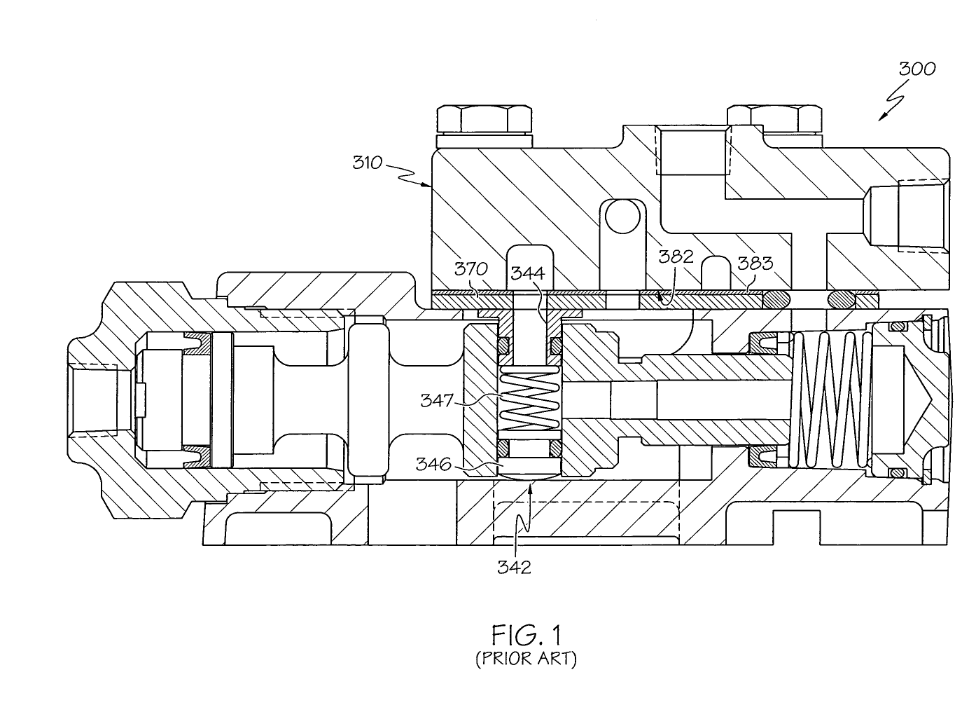

Aspects of various known pilot-operated valve assemblies may be modified to incorporate one or more aspects of the present invention. Moreover, pilot-operated valve assemblies including aspects of the present invention described herein may also incorporate one or more features of known pilot-operated valves. For example the pilot-operated valve disclosed in U.S. Pat. No. 4,450,869 that issued on May 29, 1984 is incorporated by reference in its entirety and can be modified to include one or more aspects of the present invention. Still further, pilot-operated valves including aspects of the present invention described herein may also include one or more features of the pilot-operated valve disclosed in U.S. Pat. No. 4,450,869. In another example, the pilot-operated valve disclosed in U.S. Pat. No. 3,215,163 that issued on Nov. 2, 1965 is incorporated by reference in its entirety and can also be modified to include one or more aspects of the present invention. Still further, pilot-operated valves including aspects of the present invention described herein may also include one or more features of the pilot-operated valve disclosed in U.S. Pat. No. 3,215,163. Furthermore, FIG. 1 depicts a sectional view of portions of a conventional pilot-operated valve 300 that can be modified to include one or more aspects of the present invention. Still further, pilot-operated valves including aspects of the present invention described herein may also include one or more features of the conventional-operated valve 300 illustrated in FIG. 1.

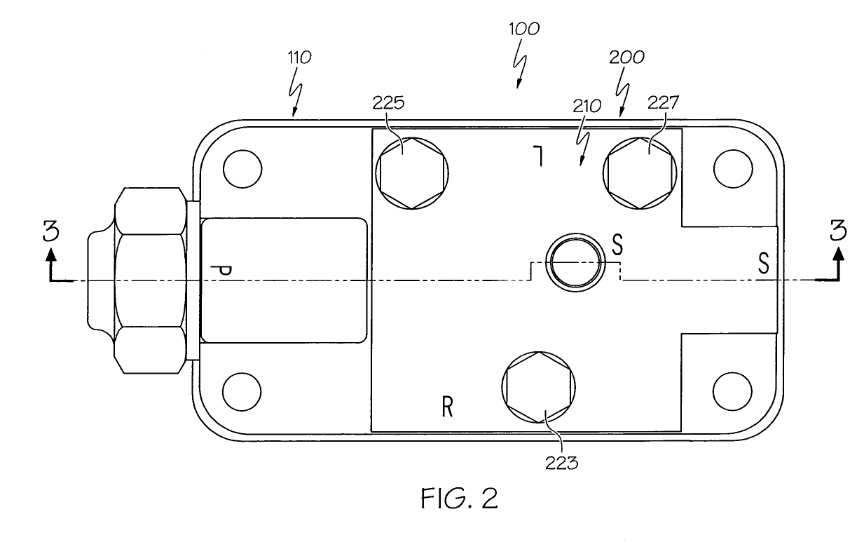

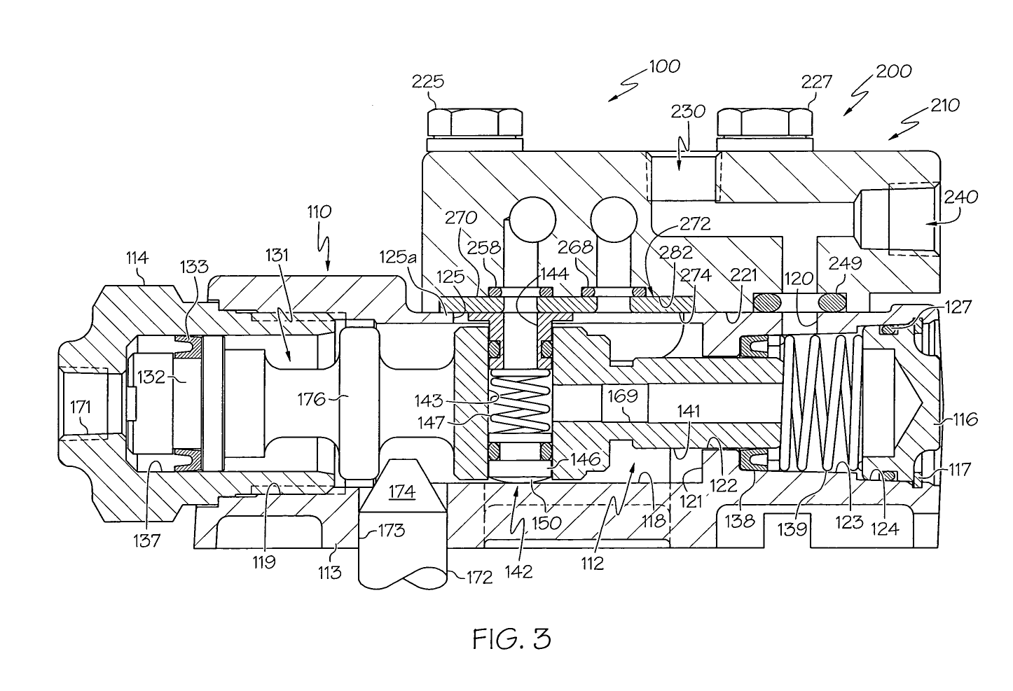

By way of illustration, FIGS. 2 and 3 depict just one example of a pneumatic pilot-operated valve 100 that incorporates example aspects of the present invention. The pilot-operated valve 100 can include a body assembly 110, a manifold assembly 200, and a slide assembly 112. The body assembly 110 can include a body member 113, an end cap 114 threaded into one end of the body member 113, and a plug 116 secured in the other end of the body member 113 by a snap ring 117. The body member 113 can include a central passage 118 which is threaded at one end 119 to threadingly receive a corresponding threaded portion of the end cap 114. The passage 118 can extend with a substantially constant diameter to an inwardly extending apertured wall 121 defining a reduced diameter opening 122 coaxial with the central passage 118. Beyond the wall 121, the body member 113 can be formed with a cylindrical passage 123, which may extend to a counterbore 124. The plug 116 is positioned in the counterbore 124 and can be pressed by a coil spring 139 against the snap ring 117. A seal 127 on the plug 116 can prevent leakage of fluid under pressure between the plug 116 and the counterbore 124. The body member 113 can also include a balanced valve assembly opening 125 to facilitate an interface between the manifold assembly 200, the slide assembly 112 and body member 113.

The slide assembly 112 can include a spool member 131 formed with a seal retaining groove 132 in which a first elastomeric seal 133 is mounted. Such seal 133 can be a high clearance seal which is capable of providing a fluid tight dynamic seal between relatively spaced or high clearance parts. A similar second elastomeric seal 138 can be mounted in the body member 113 against the apertured wall 121 and can be biased by the coil spring 139 toward such position. As shown, the second seal 138 can be fixed against movement with respect to the body member 113 and provides a fluid tight seal between the body member 113 and a cylindrical outer surface 141 of the spool member 131. Various seals and seal profiles may be used for the first and second elastomeric seals. For instance, as shown, the seals can comprise a U-shaped O-ring type seal. In further examples, the seals can comprise a “K-type” seal although other seal types may be used in further examples.

A balanced valving assembly 142 can be located within a crossbore 143 of the spool member 131. The crossbore 143 is configured to receive a floating valve member 144 and a floating reaction member 146 that are urged in opposite directions by a central coil spring 147. As shown in FIG. 3, the floating valve member 144 extends at least partially through the balanced valve assembly opening 125 and is biased against the second surface 274 of the valve plate 270 by the central coil spring 147. Seals are provided on each member 144 and 146 to prevent leakage between the spool member 131 and the respective members 144, 146. Such seals may each be designed to provide a substantially zero leakage seal. Furthermore, the balancing valve assembly 142 can be configured such that there are insignificant lateral resistance forces, or substantially no lateral resistance forces, applied to the spool member 131 by the balancing valve assembly 142. The floating reaction member 146 can be provided with a curved surface 150 to form a low friction interface with the body member 113 formed from aluminum, aluminum alloy, or other relatively light-weight, relatively inexpensive, or other material. In addition, or alternatively, the curved surface 150, a layer over the curved surface 150, or the entire floating reaction member 146 may comprise a low friction material such as a Teflon® material or the like. Providing a low friction interface can prevent significant lateral resistance forces between the body member 113 and the slide assembly 112 and can reduce significant wear between parts. It is noted that the interface between the curved surface 150 and the body member 113 is not required to form a seal. Reference may be made to U.S. Pat. No. 3,215,163 for a more detailed description of the operation of an example balancing valve assembly, which has been incorporated by reference in its entirety.

A central passage 169 extends along the spool member 131 from the right end thereof, as viewed in FIG. 3, to the crossbore 143 so that supply pressure can be provided in the crossbore 143. Control pressure from a pilot valve or the like is connected to the left end of the pilot-operated valve 100 through a central port 171 formed in the end cap 114.

A lock pin 172 can also be provided to extend through a side bore 173 into the body member 113 and operates, when extended, to mechanically lock the spool member 131 in one or the other of its operative positions. The lock pin 172 can be retracted by a mechanism (not illustrated) to allow valve operation. The end 174 of the lock pin 172 can be formed with a conical shape and such conical end extends radially inward beyond the periphery of a land 176 of the spool member 131. When the lock pin 172 is in the illustrated position, the spool cannot shift to the right even when operating pressure is supplied to the central port 171. However, when the lock pin 172 is retracted while pressure is supplied to the central port 171, the spool member 131 shifts to the right from the illustrated position to the second operative position. If the lock pin 172 is again extended, the lock pin 172 can retain the spool member 131 in the second operative position until the lock pin 172 is retracted again, even if control pressure is removed from the central port 171.

As shown, the edges of the land 176 can be radiused so that a sharp edge does not engage the conical end 174. The conical end 174 of the lock pin 172 in combination with the radiused land 176 can reduce the force required to retract the lock pin 172 even when the spool member 131 is biased to shift to the left or the right.

It should also be noted that substantial radial clearance can be provided between the various portions of the spool member 131 and adjacent portions of the body member 113. Since there are no significant pressure-induced forces tending to radially displace the spool member 131, the spool can be effectively centered by the two seals 133 and 138. Consequently, rubbing contact between the spool member 131 and the body member 113 can be reduced or eliminated to reduce or eliminate wear between the parts. Example pilot-operated valves 100 can therefore be designed to substantially limit sliding or rubbing contact at the interface between the seal 133 and a cylindrical wall 137 of the end cap 114, the interface between the seal 138 and the cylindrical outer surface 141 of the spool member 131, the interface between the floating valve member 144 and a second surface 274 of a valve plate 270, and the interface between the curved surface 150 and the body member 113.

Although a wide range of materials may be used, the spool member 131 and the end cap 114 can be formed of steel which may be nickel-plated to provide a wear-resistant, good sealing surface for the dynamic seals. The body member 113, on the other hand, can be formed from a die casting of aluminum, aluminum alloy, relatively light-weight, relatively inexpensive, or other material since the body member 113 is not subject to metal-to-metal wear contact. In further examples, substantially all of the parts of the pilot-operated valve 100 can be formed with corrosion-resistant material to minimize any corrosion concerns.

Further, since high clearances are provided between the moving parts in example valves, malfunctions caused by the presence of dust, dirt, or other contamination can be virtually eliminated and the pilot-operated valve can properly function even when substantial amounts of contamination are present. The pilot-operated valve 100 can also include one or more exhaust ports, such as those illustrated and discussed with respect to FIG. 6 in U.S. Pat. No. 4,450,869.

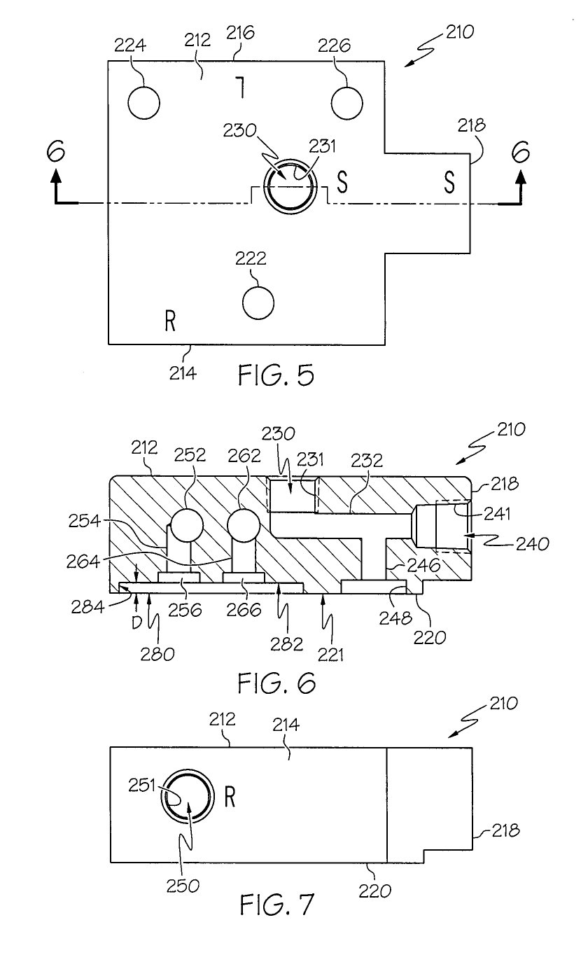

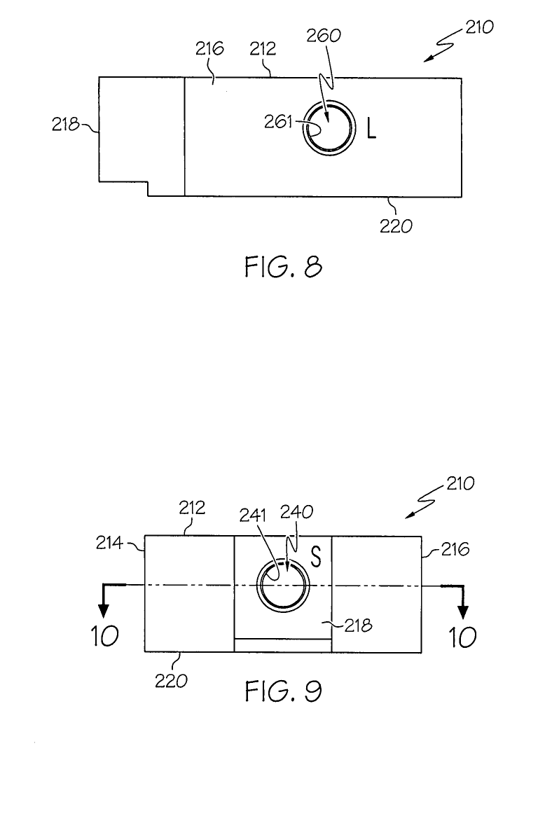

The manifold assembly 200 includes a manifold body 210 including a bottom surface 221. The manifold body 210 can be provided with a plurality of ports for connecting the pilot-operated valve 100 to the associated system. For instance, the manifold body 210 can include at least one supply port to connect to a supply line. As shown in FIGS. 5, 6 and 9, for example, the manifold body 210 can include a first supply port 230 located on a top side 212 of the manifold body 210 and a second supply port 240 located an another side 218 of the manifold body 210, although a single or more than two supply ports may be incorporated in similar or different locations of the manifold body 210 in further examples of the present invention. Providing a plurality of supply ports can be beneficial in certain applications, for example, to facilitate installations of the pilot-operated valve 100 in a plurality of alternative positions. If a plurality of supply ports are provided, unused ports may be plugged with an end cap or other arrangement. Still further, if a plurality of supply ports are provided, a pilot valve (not shown) or other device may optionally be provided in association with one of the supply ports. For example, one of the first and second supply ports 230, 240 may be operably connected with a pilot valve (not shown) or other device while the other of the first and second supply ports 230, 240 may be connected to a supply line. Each supply port 230, 240 is shown with a corresponding threaded portion 231, 241 configured to couple with a supply line, pilot valve, end cap, or other device in a fluid tight manner.

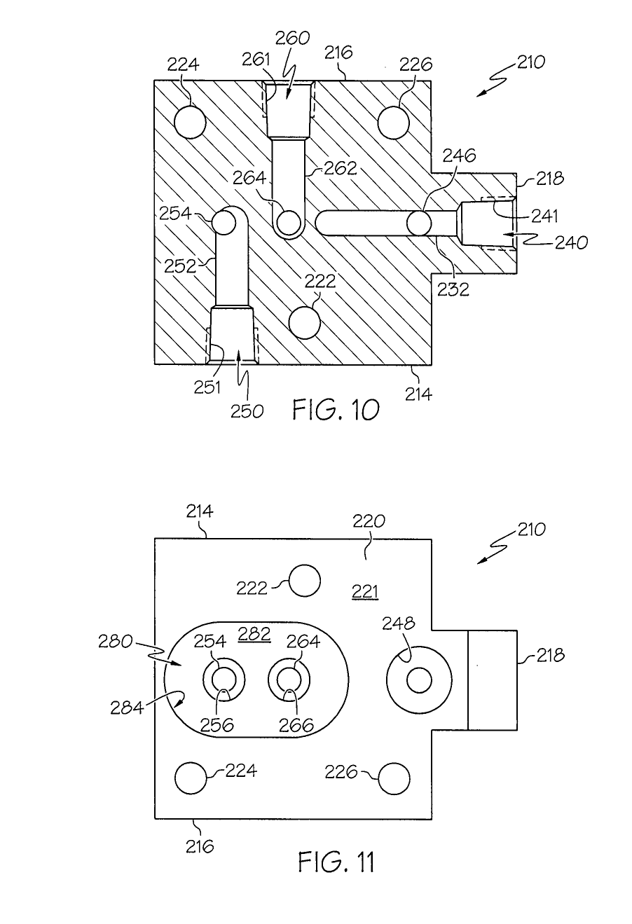

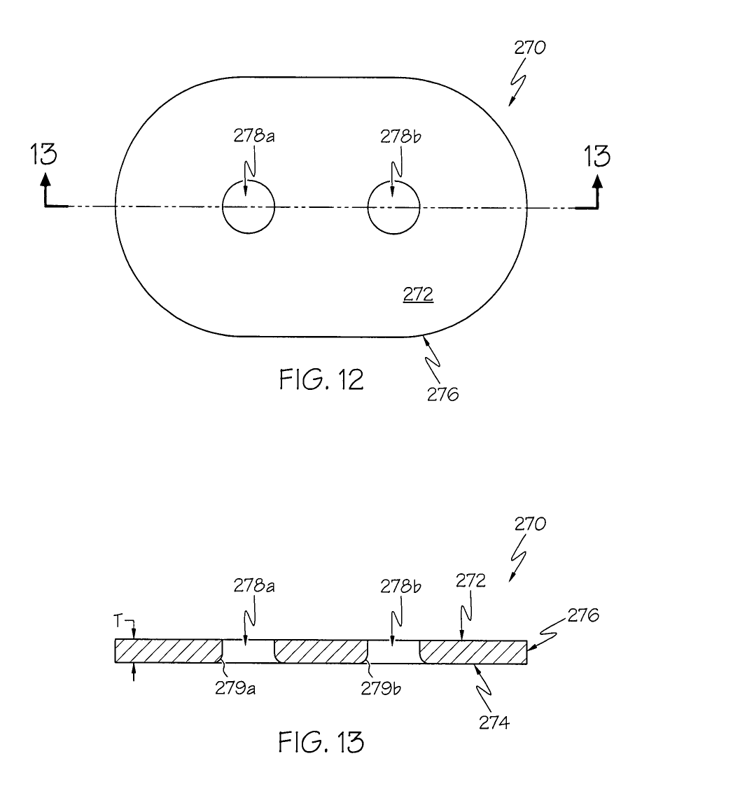

As further shown in FIGS. 6 and 10, the manifold body 210 may be configured such that each supply port 230, 240 is in fluid communication with a manifold supply opening 248 in a bottom 220 of the manifold body 210. For example, as shown in FIG. 6, a connecting passage 232 provides fluid communication between the first supply port 230 and the second supply port 240. Furthermore, a supply opening passage 246 provides fluid communication between a manifold supply opening 248 and the connecting passage 232 such that each of the supply ports 230, 240 are in fluid communication with the manifold supply opening 248 in the bottom 220 of the manifold body 210.

The illustrated manifold body 210 can also include a first control port 250 and a second control port 260 that can each include a respective threaded portion 251, 261 configured to be coupled with a corresponding control line. In the illustrated example, the control ports 250, 260 can be located on opposite sides 214, 216 of the manifold body 210 although it is contemplated that the control ports may be located at different locations of the manifold body in further examples. Moreover, as illustrated, the first control port 250 and the second control port 260 can each comprise a single port. Providing a single port can simplify installation of the pilot-operated valve 100 in certain applications where only a single control port location for each control port 250, 260 is required.

Although not shown, it is contemplated one or both of the first control port 250 and the second control port 260 can each comprise plurality of control ports. For instance, the first control port 250 can comprise two or more ports in fluid communication with one another and located on opposite sides 214, 216 or other locations of the manifold body 210. In addition or alternatively, the second control port 260 can likewise comprise two or more ports in fluid communication with one another and located on opposite sides 214, 216 or other locations of the manifold body 210. Providing one or both of the control ports 250, 260 as a plurality of control ports can be beneficial in certain applications, for example, to facilitate installation of the pilot-operated valve 100 in a plurality of alternative positions. Moreover, if one or both of the first and second control ports 250, 260 comprise a plurality of control ports, unused ports may be plugged with an end cap or other arrangement.

As illustrated in FIGS. 2, 4, 5 and 7-9, indicia can optionally be provided adjacent the various port locations to inform an observer or installer of the port configuration. For example, an “R” can be provided adjacent the first control port 250 as shown in FIGS. 2, 5 and 7 to designate the first control port for fluid connection to a first side, such as a right side, of a controlled cylinder. Furthermore, an “L” can be provided adjacent the second control port 260 as shown in FIGS. 2, 4, 5 and 8 to designate the second control port for fluid connection to a second side, such as a left side, of the controlled cylinder. As shown in FIGS. 2 and 5, an “S” can be provided adjacent to each of the supply ports 230 and 240 to designate the port locations for fluid connection with the supply line and, optionally, with a pilot valve, or other device. As further shown in FIG. 2, a “P” can be provided adjacent the central port 171 to indicate where a pilot valve (not shown) may be installed.

As further shown in FIGS. 6, 10 and 11, the manifold body 210 may be configured such that the first control port 250 is in fluid communication with a first opening 256 in the bottom 220 of the manifold body 210. As shown, a first control port passage 252 can extend from the first control port 250. A first opening passage 254 also extends from the first opening 256 to the first control port passage 252 to provide fluid communication between the first control port 250 and the first opening 256. Likewise, the manifold body 210 may be configured such that the second control port 260 is in fluid communication with a second opening 266 in the bottom 220 of the manifold body 210. As shown, a second control port passage 262 can extend from the second control port 260. A second opening passage 264 also extends from the second opening 266 to the second control port passage 262 to provide fluid communication between the second control port 260 and the second opening 266.

In one example, the manifold body 210 may include a plate cavity 280 recessed from the bottom surface 221 and at least partially defined by a cavity surface 282. The manifold assembly 200 can also include a valve plate 270 configured to be positioned within the plate cavity 280. The valve plate 270 can include a first surface 272 facing the cavity surface 282 and a second surface 274 facing away from the first surface 272. In the illustrated example, the first surface 272 of the valve plate 270 and the cavity surface 282 of the plate cavity 280 are both substantially planar although other configurations may be provided in further examples. Moreover, the first surface 272 may be substantially parallel to the first surface 272. As shown in FIG. 3, the valve plate 270 can also include an outer peripheral dimension that is greater than an inner peripheral dimension of the balanced valve assembly opening 125 to permit portions of the second surface 274 to engage portions 125a of the body member 113.

In another example, the plate cavity 280 can include a depth “D” (see FIG. 6) between the cavity surface 282 of the plate cavity 280 and the bottom surface 221 of the manifold body 210. Furthermore, the valve plate 270 can include a thickness “T” (see FIG. 13) between the first surface 272 of the valve plate 270 and the second surface 274 of the valve plate 270. In further examples, the depth “D” of the plate cavity 280 can be greater than the thickness “T” of the valve plate 270 to reduce tolerance requirements when fabricating the valve plate 270 thickness. Still further, expensive machining of the cavity surface 282 of the plate cavity 280 and the first surface 272 of the valve plate 270 can be avoided since the surfaces 272, 282 can be slightly spaced from one another when the valve plate 270 is installed within the plate cavity 280. Moreover, when the valve plate 270 is installed within the plate cavity 280, the second surface 274 can be configured to be arranged substantially flush with the bottom surface 221 of the manifold body 210 as shown in FIG. 3.

The valve plate 270 can further include a first aperture 278a extending through the first surface 272 and the second surface 274 of the valve plate 270. Likewise, the valve plate 270 can further include a second aperture 278b extending through the first surface 272 and the second surface 274.

The valve plate 270 can be configured to be keyed within the plate cavity 280 in at least one selected orientation. For example, the plate cavity 280 can include a peripheral surface portion 284 that can have a peripheral shape that is geometrically similar to the peripheral shape of a peripheral surface portion 276 of the valve plate 270. Providing the peripheral surface portions 284, 276 that have geometrically similar shapes can help appropriately align and maintain the position of the valve plate 270 with respect to the manifold body 210. In one example, the at least one selected orientation includes a single orientation wherein the valve plate can only be keyed in the plate cavity in a single orientation. Providing a valve plate that can only be keyed into the valve cavity in a single orientation can force alignment between the first and second apertures 278a, 278b and the respective first and second openings 256, 266.

In the illustrated example, due to the oblong symmetrical geometric shape of the valve plate 270 and corresponding valve plate cavity 280, the at least one selected orientation can include a first orientation and a second orientation, although more than two orientations may be provided in further examples. As shown, in the first orientation, a first aperture 278a of the valve plate 270 is aligned with the first opening 256 of the manifold body 210 and a second aperture 278b if the valve plate 270 is aligned with the second opening 266 of the manifold body 210. In the second orientation, the first aperture 278a of the valve plate 270 is aligned with the second opening 266 of the manifold body 210 and the second aperture 278b of the valve plate 270 is aligned with the first opening 256 of the manifold body 210. Thus, as shown, the valve plate 270 may be installed with either aperture 278a, 278b aligned with either opening 256, 266.

As shown, the first opening 256 and the second opening 266 extend through the cavity surface 282. In one example, at least one seal can be configured to provide a first fluid tight seal between the first aperture 278a and the first opening 256 and configured to provide a second fluid tight seal between the second aperture 278b and the second opening 266. In one example, the fluid tight seal comprises a single seal although two or more seals may be provided in further examples. For instance, as shown, the at least one seal comprises a first seal 258 and a second seal 268. The first opening 256 can be provided with the first seal 258 to provide a first fluid tight seal between the first aperture 278a and the first opening 256. Likewise, the second opening 266 can be provided with the second seal 268 to provide a second fluid tight seal between the second aperture 278b and the second opening 266. Although a wide variety of seals and/or materials may be used, the illustrated example includes seals 258, 268 comprising elastomeric O-ring seals seated within countersunk portions of the respective openings 256, 266 in the cavity surface 282 of the plate cavity 280.

In another example, the manifold supply opening 248 can extend through the bottom surface 221 of the manifold body 210 although the manifold supply opening can extend through the cavity surface 282 in further examples. The manifold supply opening 248 can be provided with a seal 249 to facilitate a fluid tight seal between the manifold supply opening 248 and a supply opening 120 in the body member 113. Although a wide variety of seals and/or materials may be used, the illustrated example includes a seal 249 comprising an elastomeric O-ring seal seated within a countersunk portion of the manifold supply opening 248 in the bottom 220 of the manifold body 210.

The manifold body 210 and the valve plate 270 may be formed in a wide variety of ways and from a wide variety of materials. The valve plate 270 can include a material that is harder than a material of the manifold body 210. The valve plate 270 can also include a material that has a higher wear resistance than a material of the manifold body 210. For instance, the manifold body 210 can be formed from as a casting from aluminum or an aluminum alloy or other material. In further examples, the valve plate 270 can be stainless steel, ceramic, or other suitable corrosion and wear-resistant material. Moreover, the second surface 274 can be polished, such as with a lapping technique, to obtain a smooth surface to maintain a sealing interface between the valve plate 270 and the floating valve member 144 as the floating valve member 144 reciprocates between, and aligns with, the first and second apertures 278a, 278b of the valve plate 270. In further examples, one or both of the apertures 278a, 278b may be provided with a rounded opening portion 279a, 279b to reduce potential wearing of the floating valve member 144 that might otherwise occur from burs or sharp corners associated with the apertures 278a, 278b.

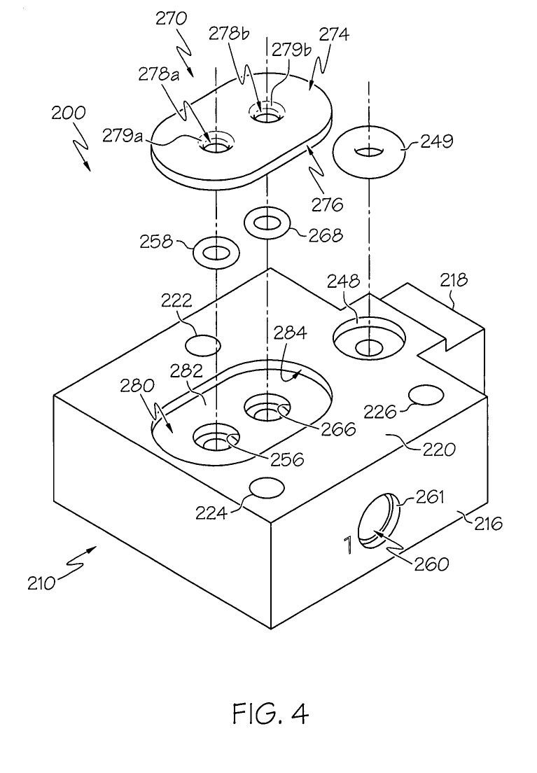

An example method of assembling the manifold assembly 200 and mounting the manifold assembly 200 to the body assembly 110 will now be described. In one example, the manifold body 210 can be turned over as shown in FIG. 4, and the first seal 258 can then be inserted into the countersunk portion of the first opening 256 and the second seal 268 can be inserted into the countersunk portion of the second opening 266. The valve plate 270 can then be at least partially inserted over or within the plate cavity 280 such that the first and second apertures 278a, 278b are substantially positioned over the respective first and second openings 256, 266. The seal 249 can also be seated within the countersunk portion of the manifold supply opening 248.

Once assembled, manifold assembly 200 can then be turned over and mounted to the body assembly 110. Referencing FIG. 5, the manifold body 210 includes first, second and third fastener apertures 222, 224, 226 that can be aligned with corresponding apertures in the body member 113. Corresponding screws 223, 225, 227 may then be used to mount the manifold assembly 200 to the body assembly 110. Once tightened, the central coil spring 147 of the balancing valve assembly 142 is compressed such that the floating valve member 144 is firmly seated against the second surface 274 of the valve plate 270. Tightening still further causes the seal 249 to provide a fluid tight seal between the manifold supply opening 248 and a supply opening 120 in the body member 113. Tightening of the screws 223, 225, 227 also causes the seals 258, 268 to provide a fluid tight seal between the manifold body 210 and each aperture 278a, 278b of the valve plate 270. The seals 258, 268 can also act as a biasing mechanism to bias the valve plate 270 toward the body assembly 110 such that portions of the second surface 274 of the valve plate 270 are forced to engage portions 125a of the body member 113 adjacent the balanced valve assembly opening 125. Once tightened, the portions 125a of the body member 113 press the valve plate 270 further into the plate cavity 280, against the bias of the seals 258, 268, until the second surface 274 of the valve plate 270 is substantially flush with the bottom surface 221 of the manifold body 210. Once mounted, the valve plate 270 is trapped from lateral movement within the plate cavity 280 since the shape of the peripheral surface portion 276 of the valve plate 270 is geometrically similar to the shape of the peripheral surface portion 284 of the plate cavity 280. The valve plate 270 is further trapped by the portions 125a of the body member 113 and the biasing force of the seals 258, 268 from being moved further into or out of the plate cavity 280.

One example of operating the pilot-operated valve 100 will now be described. Referencing FIG. 2, supply pressure can be supplied to the crossbore 143 through one or the other of the supply ports 230, 240. For example, pressurized fluid from the one or the other of the supply ports 230, 240 passes through the supply opening 120 and then into the cylindrical passage 123 of the body member 113. The right end of the spool member is pressurized with supply pressure and the spool is urged to the left (as viewed in FIG. 3) so long as the left end of the spool is not also pressurized. Further, the supply pressure communicates through the first opening 256 to the first control port 250. In this configuration, the second control port 260 is in communication with the valve exhaust port by way of the second opening 266. While the connected cylinder or the like is operating, any exhaust air can be carried out, for example, through large exhaust ports and past the flap valves as described in U.S. Pat. No. 4,450,869. Any contamination which collects in the valve tends to be flushed out during such time.

When operating pressure is supplied to the central port 171 through a pilot valve (not illustrated), the left side of the spool member 131 is pressurized as well as the right side. Since the effective area of the left end of the spool member 131 is greater than the effective area of the right end of the spool member 131, a fluid pressure-induced force is exerted on the spool member 131, tending to shift the spool member 131 to the right, from the position illustrated in FIG. 3, to the other operative position. If the lock pin 172 remains extended when this occurs, the land 176 engages the lock pin 172 and movement of the spool member 131 to the right cannot occur. However, as soon as the lock pin 172 is retracted while pressure remains on the left side of the spool member 131, the spool member 131 shifts to the right to the other operative position such that the pressurized supply fluid passes through the second opening 266 to the second control port 260. In this configuration, the first control port 250 is in communication with the valve exhaust port by way of the first opening 256. If the lock pin 172 is then extended, the spool member 131 is then locked in its operative right position even if control pressure is removed from the central port 171. Subsequently, the spool member 131 can be shifted to the left, back to the first operative position illustrated in FIG. 3, by removing the pressure from the central port 171 while the lock pin 172 is retracted.

In the illustrated embodiment, the first seal 133 is mounted on the spool member 131 while the second seal 138 is mounted on the body member 113. Such a combination can provide a maximum differential area for valve operation within a relatively small space. In instances in which greater space is available, it may be desirable to provide both of the seals on the body member so that the end cap 114 need not be formed of wear-resistant material.

Example pilot-operated valves can be fabricate with a substantial amount of the valve structure formed of lightweight, corrosion-resistant aluminum, aluminum alloy, or other light-weight and/or inexpensive material, which need not be subjected to sliding wear. Further, a significant number of the valve parts can be formed as castings, eliminating costs associated with substantial and expensive machining techniques. As the spool member 131 can be suspended with substantial clearance by the seals, the spool member 131 can be designed such that it does not rub against the aluminum or other light-weight material parts, thereby eliminating metal-to-metal sliding wear and providing a structure which can function satisfactorily even when substantial amounts of contamination are introduced into the valve. Further, the pilot-operated valve can be provided with large ports and large clearances to permit contaminants to be flushed out of the valve to prevent excessive accumulations thereof.

Furthermore, example pilot-operated valves 100 can comprise a relatively complex manifold body that can be die cast or the like in an inexpensive manner. The valve plate 270 can also be fabricated from stainless steel, ceramic or other material to provide a wear-resistant, corrosion-resistant interface surface for the floating valve member 144. In further examples, providing the manifold with a plate cavity 280 to receive the valve plate 270 together with seals 258, 268 can provide a simple way of mounting the valve plate 270 with respect to the manifold body 210 and the body member 113 while providing reliable sealing between each aperture 278a, 278b of the valve plate 270 and the manifold body 210. In still further examples, the size of the valve plate 270 can be reduced such that it is not interact with the manifold supply opening 248. Reducing the size of the valve plate 270 can reduce the overall costs of producing the manifold assembly 200 since less material is necessary to produce the valve plate 270 and the costs of providing a seal between each aperture 278a, 278b of the valve plate 270 and manifold body 210 can be reduced. Moreover, in further examples, the valve plate 270 can be arranged such that it does not interact with the manifold supply opening 248 to reduce potential leak points.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A manifold assembly comprising:
a manifold body including a bottom surface, a plate cavity recessed from the bottom surface and at least partially defined by a cavity surface, a first opening extending through the cavity surface, a second opening extending through the cavity surface, a first control port in fluid communication with the first opening, a second control port in fluid communication with the second opening, a manifold supply opening, and a supply port in fluid communication with the manifold supply opening;
a valve plate positioned within the plate cavity, the valve plate including a first surface facing the cavity surface, a second surface facing away from the first surface, a first aperture extending through the first surface and the second surface and configured to be aligned with the first opening, and a second aperture extending through the first surface and the second surface and configured to be aligned with the second opening; and
at least one seal configured to provide a first fluid tight seal between the first aperture and the first opening and configured to provide a second fluid tight seal between the second aperture and the second opening.

2. The manifold assembly of claim 1, wherein the valve plate is configured to be keyed within the plate cavity in at least one selected orientation.

3. The manifold assembly of claim 2, wherein the at least one selected orientation includes a first orientation and a second orientation, wherein the first aperture is aligned with the first opening and the second aperture is aligned with the second opening in the first orientation, and the first aperture is aligned with the second opening and the second aperture is aligned with the first opening in the second orientation.

4. The manifold assembly of claim 2, wherein the valve plate includes a peripheral shape that is geometrically similar to a peripheral shape of the plate cavity.

5. The manifold assembly of claim 1, wherein the valve plate includes a material that is harder than a material of the manifold body.

6. The manifold assembly of claim 1, wherein the valve plate includes a material that has a higher wear resistance than a material of the manifold body.

7. The manifold assembly of claim 1, wherein the valve plate includes stainless steel and the manifold body includes aluminum.

8. The manifold assembly of claim 1, wherein the at least one seal comprises a first seal configured to provide the first fluid tight seal between the first aperture and the first opening and a second seal configured to provide the second fluid tight seal between the second aperture and the second opening.

9. The manifold assembly of claim 8, wherein the first and second seals each comprise an O-ring.

10. The manifold assembly of claim 8, wherein the first opening includes a first countersunk portion and the second opening includes a second countersunk portion, wherein the first seal is seated within the first countersunk portion and the second seal is seated within the second countersunk portion.

11. The manifold assembly of claim 1, wherein a depth of the plate cavity is greater than a thickness of the valve plate.

12. The manifold assembly of claim 1, wherein the at least one seal is configured to bias at least a portion of the valve plate to extend out of the plate cavity.

13. A pilot-operated valve including the manifold assembly of claim 1, the pilot-operated valve further comprising:
a body assembly including a body member with a central passage, a balanced valve assembly opening, and a body supply opening in fluid communication with the manifold supply opening; and
a slide assembly received in the central passage of the body member, the slide assembly including a floating valve member biased to extend within the balanced valve assembly opening to contact the second surface of the valve plate, wherein the floating valve member is configured to be placed in selective communication with the first aperture and the second aperture.

14. The pilot-operated valve of claim 13, wherein an outer peripheral dimension of the valve plate is greater than an inner peripheral dimension of the balanced valve assembly opening.

15. A manifold assembly comprising:
a manifold body including a bottom surface, a plate cavity recessed from the bottom surface and at least partially defined by a cavity surface, a first opening extending through the cavity surface, a second opening extending through the cavity surface, a first control port in fluid communication with the first opening, a second control port in fluid communication with the second opening, a manifold supply opening extending through the bottom surface of the manifold body, and a supply port in fluid communication with the manifold supply opening;
a valve plate including a material that has a higher wear resistance than a material of the manifold body, wherein the valve plate is configured to be keyed within the plate cavity in at least one selected orientation and wherein a depth of the plate cavity is greater than a thickness of the valve plate, the valve plate including a first surface facing the cavity surface, a second surface facing away from the first surface, a first aperture extending through the first surface and the second surface and configured to be aligned with the first opening, and a second aperture extending through the first surface and the second surface and configured to be aligned with the second opening, wherein the second surface of the valve plate is configured to be arranged substantially flush with the bottom surface of the manifold body; and
at least one seal configured to provide a first fluid tight seal between the first aperture and the first opening and configured to provide a second fluid tight seal between the second aperture and the second opening, wherein the at least one seal is configured to bias at least a portion of the valve plate to extend out of the plate cavity.

16. The manifold assembly of claim 15, wherein the valve plate includes stainless steel and the manifold body includes aluminum.

17. A pilot-operated valve including the manifold assembly of claim 15, the pilot-operated valve further including:
a body assembly including a body member with a central passage, a balanced valve assembly opening, and a body supply opening in fluid communication with the manifold supply opening; and
a slide assembly received in the central passage of the body member, the slide assembly including a floating valve member biased to extend within the balanced valve assembly opening to contact the second surface of the valve plate, wherein the floating valve member is configured to be placed in selective communication with the first aperture and the second aperture.

18. The pilot-operated valve of claim 17, wherein an outer peripheral dimension of the valve plate is greater than an inner peripheral dimension of the balanced valve assembly opening.

19. A pilot-operated valve comprising:
a body assembly including a body member with a top surface, a central passage, a balanced valve assembly opening extending through the top surface, and a body supply opening extending through the top surface;
a manifold assembly mounted to the body member, the manifold assembly including a manifold body with a bottom surface, a plate cavity recessed from the bottom surface and at least partially defined by a cavity surface, a first opening extending through the cavity surface, a second opening extending through the cavity surface, a first control port in fluid communication with the first opening, a second control port in fluid communication with the second opening, a manifold supply opening aligned with the body supply opening, and a supply port in fluid communication with the manifold supply opening;
the manifold assembly further comprising a valve plate positioned within the plate cavity, the valve plate including a first surface facing the cavity surface, a second surface facing away from the first surface, a first aperture extending through the first surface and the second surface and aligned with the first opening, and a second aperture extending through the first surface and the second surface and aligned with the second opening;
the manifold assembly further comprising at least one seal configured to provide a first fluid tight seal between the first aperture and the first opening and configured to provide a second fluid tight seal between the second aperture and the second opening; and
a slide assembly received in the central passage of the body member, the slide assembly including a floating valve member extending at least partially through the balanced valve assembly opening and biased against the second surface of the valve plate, wherein the floating valve member is configured to be placed in selective communication with the first aperture and the second aperture.

20. The manifold assembly of claim 19, wherein a depth of the plate cavity is greater than a thickness of the valve plate and a surface of the body member presses against a portion of the second surface of the valve plate to counter a bias of the at least one seal such that the bottom surface of the manifold body is flush with the second surface of the valve plate.
